(19) United States
(12) Patent Application Publication
(10) Pub. No.: US 2024/0385789 A1
(43) Pub. Date: Nov. 21, 2024

(54) NON-TRANSITORY COMPUTER-READABLE RECORDING MEDIUM STORING COMPUTER-READABLE INSTRUCTIONS FOR FIRST SERVER, AND NON-TRANSITORY COMPUTER-READABLE RECORDING MEDIUM STORING COMPUTER-READABLE INSTRUCTIONS FOR TERMINAL DEVICE

(71) Applicant: BROTHER KOGYO KABUSHIKI KAISHA, Nagoya (JP)

(72) Inventors: Yoshifumi YAHASHI, Nagoya (JP); Yukinori MINAMIYAMA, Nagoya (JP)

(21) Appl. No.: 18/663,839

(22) Filed: May 14, 2024

(30) Foreign Application Priority Data
May 15, 2023 (JP) 2023-079971
Feb. 2, 2024 (JP) 2024-014720
Mar. 27, 2024 (JP) 2024-051306
Mar. 27, 2024 (JP) 2024-051331
Mar. 27, 2024 (JP) 2024-052386

(51) Int. Cl. G06F 3/12; H04N 1/34

(52) U.S. Cl. CPC G06F 3/1238; G06F 3/1222; H04N 1/344

(57) ABSTRACT

The first server may receive user identification information for identifying a user from a terminal device, receive, from the terminal device, a service subscription request. The first server may, in a case where the user identification information and the service subscription request are received from the terminal device, send a sending request including the user identification information to a second server and, in a case where the sending request is sent to the second server and first registration information is received from the second server, store the first registration information as information for providing the first service to the user in a memory in association with the user identification information. In a case where the sending request is sent to the second server but no registration information is received from the second server, no registration information may be stored in the memory.

### REFERENCE TO RELATED APPLICATIONS

This application claims priority to Japanese Patent Application No. 2023-079971 filed on May 15, 2023, No. 2024-014720 filed on Feb. 2, 2024, No. 2024-052386 filed on Mar. 27, 2024, No. 2024-051306 filed on Mar. 27, 2024 and No. 2024-051331 filed on Mar. 27, 2024. The entire contents of the priority applications are incorporated herein by reference.

### BACKGROUND ART

A communication system including a printer, a PC, and an information management server is known. Each time a flat-rate printing process is executed, the printer stores print information related to the number of printed sheets and sends the print information to the information management server. When receiving the print information from the printer, the information management server manages the print information. The information management server provides a service of the flat-rate printing process using the print information received from the printer.

### SUMMARY

The disclosure herein provides teachings to improve user's convenience when a user subscribes to a service.

Disclosed herein is a non-transitory computer-readable recording medium storing computer-readable instructions for a first server. The first server may be configured to provide a first service. The first server may comprise a processor. The computer-readable instructions, when executed by the processor, may cause the first server to: receive user identification information for identifying a user from a terminal device; receive, from the terminal device, a service subscription request that requests a subscription to the first service; in a case where the user identification information and the service subscription request are received from the terminal device, send a sending request including the user identification information to a second server different from the first server, the sending request being a signal that requests sending of registration information stored in the second server in association with the user identification information; and in a case where the sending request is sent to the second server and first registration information is received from the second server, store the first registration information as information for providing the first service to the user in a memory in association with the user identification information, wherein in a case where the sending request is sent to the second server but no registration information is received from the second server, no registration information is stored in the memory.

According to the configuration above, in the case where the first server sends the sending request to the second server and receives the first registration information from the second server, the first server stores the first registration information as information for providing the first service to the user in the memory in association with the user identification information. Therefore, the user's convenience can be improved.

Also disclosed herein is a non-transitory computer-readable recording medium storing computer-readable instructions for a first server. The first server may be configured to provide a first service. The first server may comprise a processor and a first memory. The computer-readable instructions, when executed by the processor, may cause the first server to: receive, from a first external device, user related information for providing a second service different from the first service to a user; receive, from a second external device, a service subscription request that requests a subscription to the first service; in a case where the user related information is received from the first external device, the service subscription request is received from the second external device, and first registration information is in a second memory in association with the user related information as information for providing the second service to the user, acquire the first registration information from the second memory, wherein in a case where the user related information is received from the first external device, the service subscription request is received from the second external device, and no registration information is in the second memory in association with the user related information as information for providing the second service to the user, registration information is not acquired; and in a case where the first registration information is acquired from the second memory, store the first registration information as information for providing the first service to the user in the memory in association with the user related information.

According to the configuration above, the first server acquires the first registration information from the second memory in the case where the user related information is received from the first external device, the service subscription request is received from the second external device, and the first registration information is in the second memory in association with the user related information. The first server then stores, in the case where the first registration information is received from the second memory, the first registration information as the information for providing the first service to the user in the first memory in association with the user related information. Therefore, the user's convenience can be improved.

Also disclosed herein is a non-transitory computer-readable recording medium storing computer-readable instructions for a terminal device. The terminal device may comprise a processor. The computer-readable instructions, when executed by the processor, may cause the terminal device to: send a second server a sending request including user related information related to information for providing a second service to a user, wherein the second service is different from a first service provided by a first server, and the sending request is a signal that requests sending of registration information stored in the second server in association with the user related information; in a case where the sending request is sent to the second server and specific registration information is in the second server in association with the user related information, receive the specific registration information from the second server, wherein in a case where the sending request is sent to the second server and no registration information is in the second server in association with the user related information, registration information is not received from the second server; in a case where the specific registration information is received from the second server, send the specific registration information to the first server; send the user related information to the first server; and send the first server a service subscription request that requests a subscription to the first service, wherein in a case where the specific registration information is received from the terminal device, the user related information is received from the terminal device, and the service subscription request is received from the terminal device, the first server is configured to store the specific registration information as information for providing the first service to the user in association with the user related information.

According to the configuration above, the terminal device sends the sending request including the user related information to the second server. In the case where the specific registration information is received from the second server, the terminal device sends the specific registration information to the first server. The first server then stores the specific registration information as the information for providing the first service to the user in association with the user related information. Therefore, the user's convenience can be improved.

The first server implemented by the above computer-readable instructions and a method performed by the first server are also novel and useful. A communication system comprising the first server, the second server, and the terminal device is also novel and useful. Further, the terminal device implemented by the above computer-readable instructions for the terminal device and a method performed by the terminal device are also novel and useful.

### BRIEF DESCRIPTION OF DRAWINGS

FIG. 1 shows a configuration of a communication system.

FIG. 2 shows examples of tables.

FIG. 3 shows a sequence diagram for a service subscription process.

FIG. 4 shows a sequence diagram for a service cancellation process.

FIG. 5 shows a flowchart for a registration process.

FIG. 6 shows a sequence diagram for Case A according to a first embodiment.

FIG. 7 shows an example of authentication table.

FIG. 8 shows a sequence diagram for Case B according to a second embodiment.

FIG. 9 shows a sequence diagram for Case C according to a third embodiment.

FIG. 10 shows a sequence diagram for Case D according to a fourth embodiment.

FIG. 11 shows a sequence diagram for Case E according to a fifth embodiment.

### DESCRIPTION

### First Embodiment

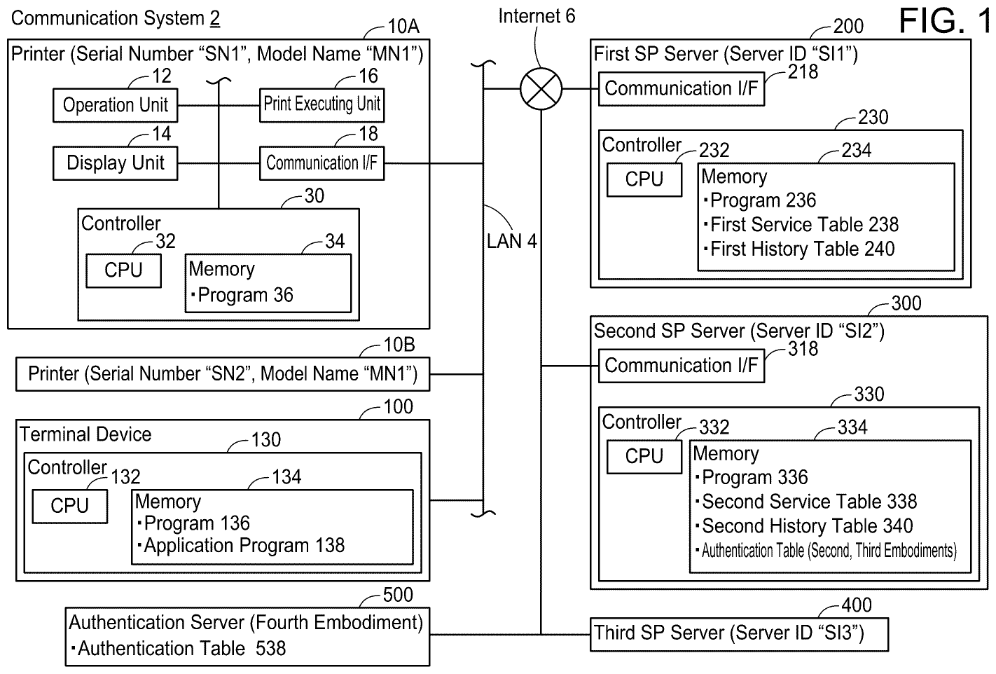

### (Configuration of Communication System 2: FIG. 1)

As shown in FIG. 1, a communication system 2 includes a plurality of printers 10A, 10B, a terminal device 100, a first service provision server 200, a second service provision server 300, and a third service provision server 400. Hereinafter, “service provision server” is abbreviated as “SP server”. The printers 10A, 10B and the terminal device 100 are connected to a LAN (local area network) 4. The printers 10A, 10B and the terminal device 100 can communicate with each other via the LAN 4. The LAN 4 is connected to the internet 6. The printers 10A, 10B, the terminal device 100, the first SP server 200, the second SP server 300, and the third SP server 400 are connected to the internet 6. They can communicate with each other via the internet 6.

### (Configurations of Printers 10A, 10B)

The printer 10A is a peripheral device (i.e., a peripheral device of a PC, etc.) configured to execute a print function. The printer 10A may be a multifunctional device configured to execute a scan function, a FAX function, etc. in addition to the print function. The printer 10A includes an operation unit 12, a display unit 14, a print executing unit 16, a communication interface 18, and a controller 30. The printer 10A has a serial number “SN1” and a model name “MN1”. A serial number is an identification number assigned to a printer during its manufacturing process. A model name indicates a model of a printer. Hereinafter, an interface is abbreviated as “I/F”.

The operation unit 12 includes a plurality of keys. A user can input various instructions to the printer 10A by operating the operation unit 12. The display unit 14 is a display for displaying various information. The print executing unit 16 includes a print mechanism of inkjet scheme. In a modification, the print executing unit 16 may include a print mechanism of laser scheme. The communication I/F 18 is connected to the LAN 4. The communication I/F 18 may be a wireless I/F or a wired I/F.

The controller 30 includes a CPU 32 and a memory 34. The CPU 32 executes various processes according to a program 36 stored in the memory 34. The memory 34 is configured of a volatile memory, a non-volatile memory, etc. The memory 34 stores sheet information and remaining amount information. The sheet information indicates the number of sheets printed by the printer 10A. The remaining amount information indicates a remaining amount of ink in a cartridge mounted at the print executing unit 16 of the printer 10A.

The printer 10B has the same configuration as that of the printer 10A, except that the printer 10B has a serial number “SN2” and a model name “MN2”. Hereinafter, the printers 10A, 10B may be collectively termed “printers”.

### (Configuration of Terminal Device 100)

The terminal device 100 is a portable terminal device such as a mobile phone (e.g., a smartphone), a PDA, a tablet PC, or the like. The terminal device 100 includes a controller 130. The controller 130 includes a CPU 132 and a memory 134. The CPU 132 executes various processes according to an Operating System (OS) program 136 stored in the memory 134. The memory 134 is configured of a volatile memory, a non-volatile memory, etc. The memory 134 further includes an application program 138. The application program 138 is a program for letting the user subscribe to a service.

### (Configurations of First SP Server 200, Second SP Server 300, and Third SP Server 400)

The first SP server 200 is installed on the internet 6 by the vendor of the printers. In a modification, the first SP server 200 may be installed on the internet 6 by a business operator different from the vendor. In another modification, the vendor of the printers may not prepare hardware of the first SP server 200 on their own and may use an environment provided by an external cloud computing service. In this case, the vendor of the printers prepares a program (i.e., software) for the first SP server 200 and introduces it to the above-mentioned environment to implement the first SP server 200. The same applies to the second SP server 300 and the third SP server 400.

The first SP server 200 provides a flat-rate service. The flat-rate service is a charging service that charges a predetermined fee (termed “flat fee” hereinafter) if the number of sheets printed by a printer within a predetermined time period (e.g., a month) is equal to or less than the contractual number of sheets (e.g., 1000 sheets) on one hand, and charges, if the number of sheets printed by a printer within the predetermined time period is more than the contractual number of sheets, the sum of the flat fee and a fee for the excess sheets above the contractual number of sheets on the other hand. The flat-rate service includes a first cartridge shipping service. The first cartridge shipping service is a service of automatically shipping a new cartridge in response to the ink remaining amount in a cartridge mounted at the print executing unit of a printer becoming equal to or less than a predetermined remaining amount. Even when a new cartridge is shipped, the price of the cartridge is not added to the service charge. That is, the flat-rate service charges only a fee based on the number of sheets printed by a printer within the predetermined time period. In a modification, the first SP server 200 may provide a pay-as-you-go charging service that charges a fee based on the number of sheets printed by a printer within a predetermined time period, instead of the flat-rate charging service.

The first SP server 200 includes a communication I/F 218 and a controller 230. The communication I/F 218 is connected to the internet 6. The controller 230 includes a CPU 232 and a memory 234. The CPU 232 executes various processes according to a program 236 stored in the memory 234. The memory 234 is configured of a volatile memory, a non-volatile memory, etc. The memory 234 stores a first service table 238 and a first history table 240 in addition to the program 236. The first SP server 200 has a service ID “SI1” for identifying the first SP server 200.

The second SP server 300 provides a second cartridge shipping service. The second cartridge shipping service is the same as the first cartridge shipping service, except that the second cartridge shipping service charges a fee for a new cartridge. That is, the second cartridge shipping service charges only the fee for cartridge.

The second SP server 300 includes a communication I/F 318 and a controller 330. The communication I/F 318 is connected to the internet 6. The controller 330 includes a CPU 332 and a memory 334. The CPU 332 executes various processes according to a program 336 stored in the memory 334. The memory 334 is configured of a volatile memory, a non-volatile memory, etc. The memory 334 stores a second service table 338 and a second history table 340 in addition to the program 336. The second SP server 300 has a service ID “SI2” for identifying the second SP server 300.

The third SP server 400 provides a warranty service for the printers. The warranty service includes maintenance, warranty, etc. for the printers. The third SP server 400 has a service ID “SI3” for identifying the third SP server 400.

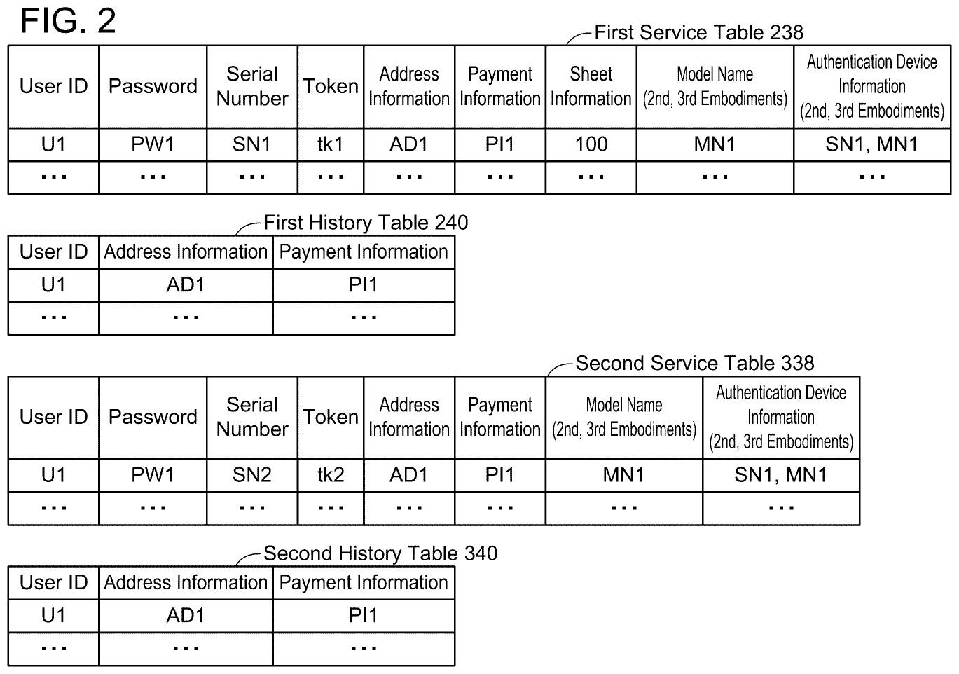

### (Contents of Tables: FIG. 2)

Referring to FIG. 2, contents of the first service table 238 and the first history table 240 in the first SP server 200 and contents of the second service table 338 and the second history table 340 in the second SP server 300 are described.

In the first service table 238 in the first SP server 200, a user ID, a password, a serial number, a token, address information, payment information, and sheet information are stored in association each other. Each user ID is information for identifying a user. Each token is information for the first SP server 200 to authenticate a printer. Each address information indicates the address of the corresponding user. Each payment information is used to make payment and is for example a credit card number. The address information and the payment information in the first service table 238 are information for providing the flat-rate service to user. Hereinafter, the address information and the payment information may be collectively termed “registration information”.

In the first history table 240 in the first SP server 200, a user ID, address information, and payment information are stored in association with each other. The address information and the payment information in the first history table 240 are information that was used when the user subscribed to the flat-rate service in the past. The information in the first history table 240 are history information registered when the user withdrew from the flat-rate service.

In the second service table 338 in the second SP server 300, a user ID, a password, a serial number, a token, address information, and payment information are stored in association with each other. That is, the second service table 338 does not include sheet information. Each token in the second service table 338 is information for the second SP server 300 to authenticate a printer. The address information and the payment information in the second service table 338 are information for providing the second cartridge shipping service to the user.

In the second history table 340 in the second SP server 300, a user ID, address information, and payment information are stored in association with each other. The address information and the payment information in the second history table 340 are information that was used when the user subscribed to the second cartridge shipping service in the past. The information in the second history table 340 are history information registered when the user withdrew from the second cartridge shipping service.

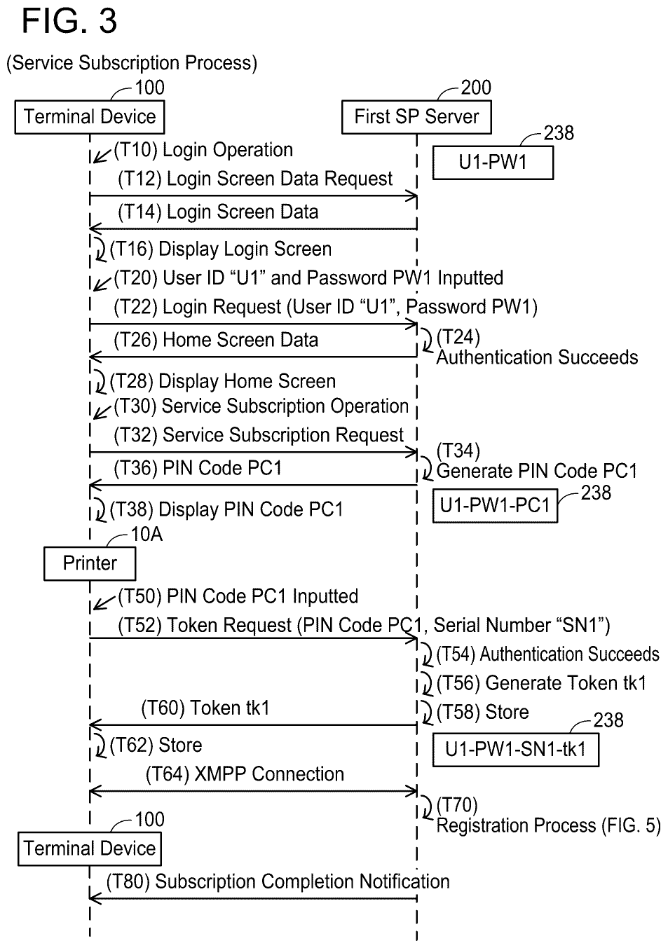

### (Service Subscription Process: FIG. 3)

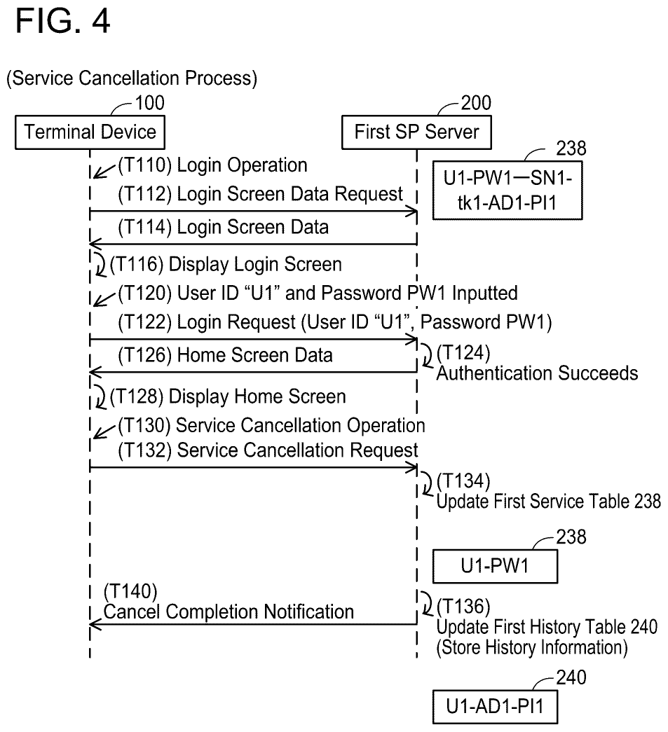

Referring to FIG. 3, a service subscription process in which a user of the terminal device 100 subscribes to the flat-rate service is described. In the initial state in FIG. 3, a user ID “U1” and a password “PW1” are stored in association with each other in the first service table 238 in the first SP server 200 and in the second service table 338 in the second SP server 300, and the first history table 240 in the first SP server 200 and the second history table 340 in the second SP server 300 are blank. For the description of the processes shown in FIGS. 3 and 4, actions performed by the respective CPUs are described with the devices as the subjects of actions, without the CPUs as the subjects of actions. Further, in the following description, communications between the devices are via their communication I/Fs. Thus, wording “via a communication I/F” is omitted in the following description about communications.

In T10, the user performs a login operation to the terminal device 100 to log into the first SP server 200. In response, the terminal device 100 sends a login screen data request to the first SP server 200 in T12, receives login screen data from the first SP server 200 in T14, and displays a login screen corresponding to the login screen data in T16. The user inputs the user ID “U1” and the password “PW1” to the terminal device 100 in T20. In response, the terminal device 100 sends a login request including the user ID “U1” and the password “PW1” to the first SP server 200 in T22.

In response to receiving the login request from the terminal device 100 in T22, the first SP server 200 determines in T24 that authentication succeeds since the combination of the user ID “U1” and the password “PW1” in the login request is in the first service table 238, and then sends home screen data to the terminal device 100 in T26.

In response to receiving the home screen data from the first SP server 200 in T26, the terminal device 100 displays a home screen corresponding to the home screen data in T28. The home screen is a screen for subscribing to the flat-rate service as well as a screen for cancelling the flat-rate service. In T30, the user performs a service subscription operation to the terminal device 100 to subscribe to the flat-rate service. In response, the terminal device 100 sends a service subscription request to the first SP server 200 in T32. The service subscription request is a signal for requesting a subscription to the flat-rate service.

In response to receiving the service subscription request from the terminal device 100 in T32, the first SP server 200 generates a PIN code PC1 and temporarily stores the PIN code PC1 in the first service table 238 in association with the user ID “U1” in T34. The first SP server 200 then sends the PIN code PC1 to the terminal device 100 in T36.

In response to receiving the PIN code PC1 from the first SP server 200 in T36, the terminal device 100 displays the PIN code PC1 in T38. Thus, the user of the terminal device 100 is able to know the PIN code PC1 to be inputted to the printer 10A.

The user inputs the PIN code PC1 to the printer 10A in T50. In response, the printer 10A sends a token request including the PIN code PC1 and the serial number “SN1” of the printer 10A to the first SP server 200 in T52.

In response to receiving the token request from the printer 10A in T52, the first SP server 200 determines in T54 that authentication succeeds since the PIN code PC1 stored in T34 matches the PIN code PC1 in the token request, and deletes the PIN code PC1 from the first service table 238. The first SP server 200 generates a token tk1 in T56 and stores the received serial number “SN1” and the generated token tk1 in the first service table 238 in association with the user ID “U1” in T58. The first SP server 200 sends the token tk1 to the printer 10A in T60.

In response to receiving the token tk1 from the first SP server 200 in T60, the printer 10A stores the received token tk1 in the memory 34 in T62. The printer 10A then establishes an XMPP (Extensible Messaging and Presence Protocol) connection with the first SP server 200 in T64 by using the token tk1. The XMPP connection is a so-called always-on connection and is maintained until the printer 10A is turned off. By using the XMPP connection, the first SP server 200 can send requests to the printer 10A through the firewall of the LAN 4 to which the printer 10A belongs, without receiving requests from the printer 10A. The first SP server 200 may send requests to the printer 10A not through the XMPP connection but by another way. For example, an HTTPS (Hypertext Transfer Protocol Secure) connection may be established between the printer 10A and the first SP server 200.

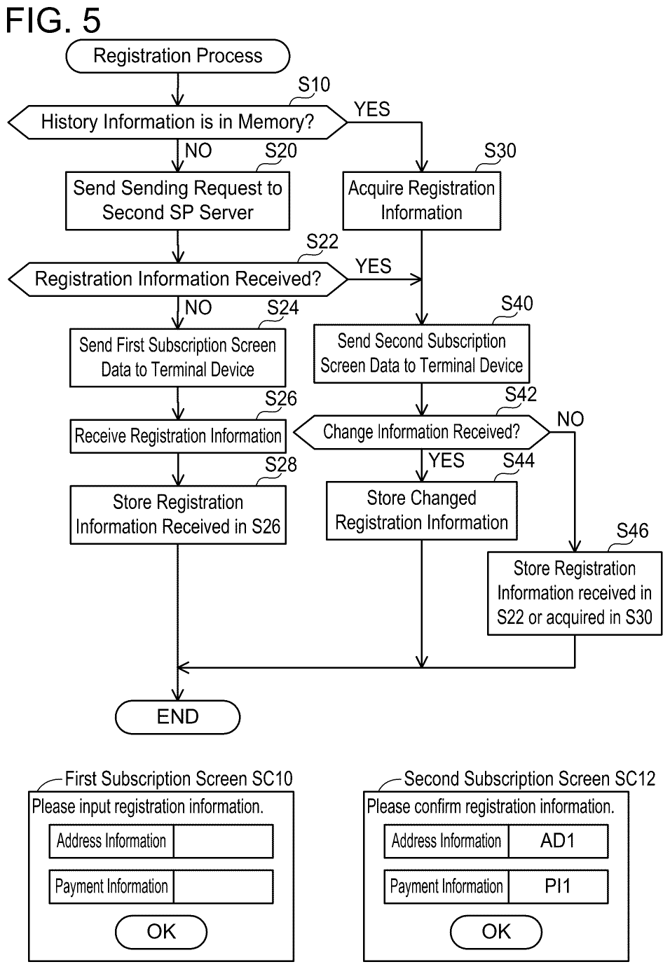

Once the XMPP connection has been established with the printer 10A in T64, the first SP server 200 executes a registration process (see FIG. 5) in T70. The registration process is for storing information necessary to provide the flat-rate service in the first service table 238. Once the registration process has been completed, the first SP server 200 sends the terminal device 100 a subscription completion notification indicating that the subscription to the flat-rate service has been completed in T80. Thus, the user of the terminal device 100 is able to know that the subscription to the flat-rate service has been completed.

Thereafter, the printer 10A sends the sheet information and the remaining amount information stored in the memory 34 to the first SP server 200 every predetermined hours (e.g., every 24 hours). In response to receiving the sheet information and the remaining amount information from the printer 10A, the first SP server 200 stores the sheet information in the first service table 238 and also determines whether the remaining amount indicated by the remaining amount information is equal to or less than a threshold. If determining that the remaining amount indicated by the remaining amount information is equal to or less than the threshold, the first SP server 200 specifies an address indicated by address information in the first service table 238 and executes a shipping process for shipping a new cartridge to the specified address. Further, the first SP server 200 specifies the number of sheets indicated by the sheet information in the first service table 238 every predetermined period (e.g., every month), and determines whether the specified number of sheets exceeds the contractual number of sheets. If the specified number of sheets does not exceed the contractual number of sheets, the first SP server 200 executes a charging process to charge the flat fee, whereas if the specified number of sheets exceeds the contractual number of sheets, the first SP server 200 execute a charging process to charge the sum of the flat fee and a fee for the extra sheets beyond the contractual number of sheets. In the charging processes, the payment information in the first service table 238 is used.

### (Service Cancellation Process: FIG. 4)

Referring to FIG. 4, a service cancellation process in which the user of the terminal device 100 cancels the flat-rate service is described. In the initial state in FIG. 4, the user ID “U1”, the password PW1, the serial number “SN1”, the token tk1, address information “AD1”, and payment information “PI1” are stored in association with each other in the first service table 238 in the first SP server 200, and the first history table 240 in the first SP server 200 is blank.

T110 to T128 are the same as T10 to T28 in FIG. 3. The user performs a service cancellation operation to the terminal device 100 to cancel the flat-rate service in T130. In response, the terminal device 100 sends a service cancellation request to the first SP server 200 in T132. The service cancellation request is a signal for requesting to cancel the flat-rate service.

In response to receiving the service cancellation request from the terminal device 100 in T132, the first SP server 200 updates the first service table 238 in T134. Specifically, the first SP server 200 deletes the serial number “SN1”, the token tk1, the address information “AD1”, and the payment information “PI1” associated with the user ID “U1” from the first service table 238. The first SP server 200 also updates the first history table 240 in T136. Specifically, the first SP server 200 stores the user ID “U1”, the address information “AD1”, and the payment information “PI1” in association with each other in the first history table 240. That is, the first SP server 200 stores, in the first service table 238, history information in which the user ID “U1” and registration information (i.e., the address information “AD1” and the payment information “PI1”) are associated with each other. In T140, the first SP server 200 sends the terminal device 100 a cancel completion notification indicating that cancellation of the flat-rate service has been completed. Thus, the user of the terminal device 100 is able to know that the cancellation of the flat-rate service has been completed.

### (Registration Process: FIG. 5)

Referring to FIG. 5, the registration process executed by the CPU 232 of the first SP server 200 in T70 of FIG. 3 is described. Hereinafter, a user ID of a logged-in user is termed a target user ID.

In S10, the CPU 232 determines whether history information including the target user ID is in the first history table 240. If the history information including the target user ID is not in the first history table 240 (NO in S10), the CPU 232 proceeds to S20. If the history information including the target user ID is in the first history table 240 (YES in S10), the CPU 232 proceeds to S30.

In S20, the CPU 232 sends a sending request including the target user ID to the second SP server 300. The sending request is a signal that requests sending of registration information stored in association with the target user ID in the second SP server 300. In response to receiving the sending request from the first SP server 200, the second SP server 300 determines whether registration information associated with the target user ID is in the second service table 338 or in the second history table 340. If determining that the registration information is in one of the tables, the second SP server 300 sends this registration information to the first SP server 200, whereas if determining that the registration information is not in either of the tables, the second SP server 300 sends a not-stored information indicating that the registration information is not in either of the tables to the first SP server 200.

In S22, the CPU 232 determines whether the registration information has been received from the second SP server 300. If the registration information has been received from the second SP server 300 (YES in S22), the CPU 232 proceeds to S40, whereas if the registration information has not been received from the second SP server 300 (NO in S22), the CPU 232 proceeds to S24.

In S24, the CPU 232 sends first subscription screen data corresponding to a first subscription screen SC10 to the terminal device 100. In response to receiving the first subscription screen data from the first SP server 200, the terminal device 100 displays the first subscription screen SC10. The first subscription screen SC10 includes a message that prompts the user to input registration information, an address information input field for inputting address information, a payment information input field for inputting payment information, and an OK button. In the first subscription screen SC10, the address information input field and the payment information input field are blank. The user inputs address information and payment information into the address information input field and the payment information input field, respectively, and selects the OK button. In response, the terminal device 100 sends registration information including the inputted address information and payment information to the first SP server 200.

In S26, the CPU 232 receives the registration information from the terminal device 100.

In S28, the CPU 232 stores the registration information received in S26 as information for providing the flat-rate service to the user in association with the target user ID in the first service table 238. Once S28 has been completed, the CPU 232 terminates the process of FIG. 5. As above, even when no registration is received from the second SP server 300, the user can subscribe to the flat-rate service by inputting registration information on his/her own. Therefore, the user's convenience is improved.

In case of YES in S10, the CPU 232 acquires the registration information associated with the target user ID in the first history table 240 in S30.

In S40, the CPU 232 sends second subscription screen data corresponding to a second subscription screen SC12 to the terminal device 100. The second subscription screen data includes the registration information received in S22 or the registration information acquired in S30. In response to receiving the second subscription screen data from the first SP server 200, the terminal device 100 displays the second subscription screen SC12. The second subscription screen SC12 includes a message that prompts the user to confirm the registration information, an address information input field for inputting address information, a payment information input field for inputting payment information, and an OK button. In the second subscription screen SC12, address information and payment information are already inputted in the address information input field and the payment information input field, respectively. Thus, the user is able to know the contents of the registration information that was used when the user subscribed to the flat-rate service in the past or the contents of the registration information that is currently used for another service, before the registration information is stored into the first service table 238. The user can change the information already inputted in the address information input field and in the payment information input field. The user may wish to change the contents of the registration information that was used when the user subscribed to the flat-rate service in the past or the contents of the registration information that is currently used for another service. The configuration above allows the user to change the contents of the registration information that was used when the user subscribed to the flat-rate service in the past or the contents of the registration information that is currently used for another service. Thus, the user's convenience can be improved. When accepting selection of the OK button from the user after at least one of the address information and the payment information has been changed, the terminal device 100 sends change information and the changed registration information to the first SP server 200. To the contrary, when accepting selection of the OK button from the user without a change in the address information and the payment information, the terminal device 100 sends OK information to the first SP server 200.

In S42, the CPU 232 determines whether the change information has been received from the terminal device 100. If the change information has been received from the terminal device 100 (YES in S42), the CPU 232 proceeds to S44, whereas if the change information has not been received from the terminal device 100 (NO in S42), the CPU 232 proceeds to S46.

In S44, the CPU 232 stores the changed registration information as information for providing the flat-rate service to the user in association with the target user ID in the first service table 238. Once S44 has been completed, the CPU 232 terminates the process of FIG. 5.

In S46, the CPU 232 stores the registration information received in S22 or the registration information acquired in S30 as information for providing the flat-rate service to the user in association with the target user ID in the first service table 238. Once S46 has been completed, the CPU 232 terminates the process of FIG. 5.

As described, if history information is in the first history table 240 (YES in S10), the CPU 232 stores the registration information included in the history information as information for providing the flat-rate service to the user in association with the target user ID in the first service table 238. This configuration allows the user to omit inputting the registration information when the user subscribes to the flat-rate service again, thereby improving the user's convenience.

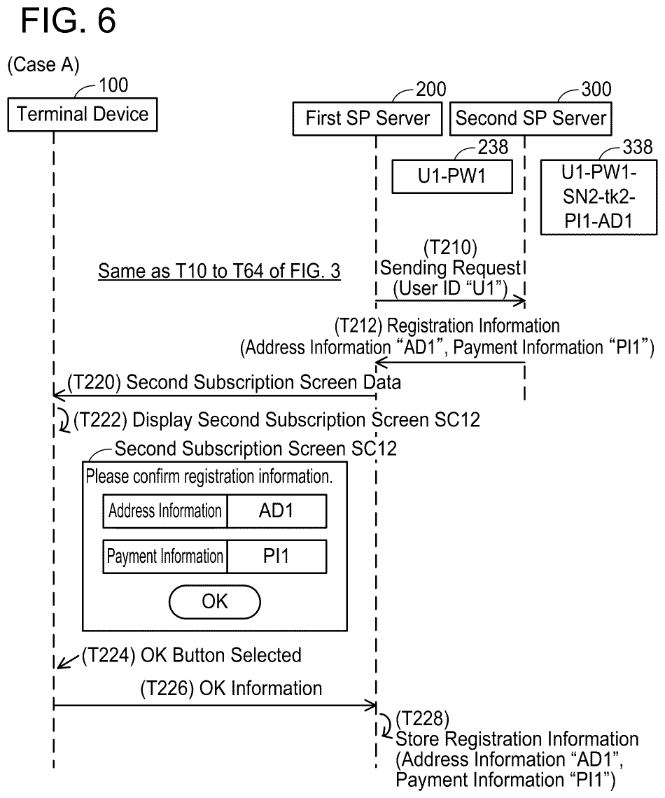

### (Case A: FIG. 6)

Referring to FIG. 6, Case A which can be realized by the communication system 2 is described. In the initial state of Case A, the user ID “U1” and the password “PW1” are stored in association with each other in the first service table 238 in the first SP server 200, and the user ID “U1”, the password “PW1”, the serial number “SN2”, a token tk2, the address information “AD1”, and the payment information “PI1” are stored in association with each other in the second service table 338 in the second SP server 300. That is, the user is subscribing to the second cartridge shipping service provided by the second SP server 300. The first history table 240 in the first SP server 200 and the second history table 340 in the second SP server 300 are blank. Hereinafter, actions performed by the respective CPUs are described with the devices as the subjects of actions, without the CPUs as the subjects of actions.

First, the same sequence as T10 to T64 in FIG. 3 is executed between the printer 10A, the terminal device 100, and the first SP server 200.

The first SP server 200 determines that history information including the user ID “U1” of the logged-in user is not in the first history table 240 (NO in S10 of FIG. 5) and sends a sending request including the user ID “U1” to the second SP server 300 in T210 (S20).

In response to receiving the sending request from the first SP server 200 in T210, the second SP server 300 specifies the registration information (i.e., the address information “AD1” and the payment information “PI1”) stored in association with the user ID “U1” in the second service table 338, and sends the specified registration information to the first SP server 200 in T212.

In response to receiving the registration information from the second SP server 300 in T212 (YES in S22), the first SP server 200 sends second subscription screen data including the registration information to the terminal device 100 in T220 (S40).

In response to receiving the second subscription screen data from the first SP server 200 in T220, the terminal device 100 displays a second subscription screen SC12 in T222. In the present case, the address information “AD1” and the payment information “PI1” are shown in the address information input field and the payment information input field, respectively, in the second subscription screen SC12. The user selects the OK button in the second subscription screen SC12 in T224. In this case, the terminal device 100 sends OK information to the first SP server 200 in T226.

In response to receiving the OK information from the terminal device 100 in T226, the first SP server 200 determines that change information has not been received from the terminal device 100 (NO in S42). In this case, the first SP server 200 stores the registration information received in T212 (i.e., the address information “AD1” and the payment information “PI1”) as information for providing the flat-rate service to the user in association with the user ID “U1” in the first service table 238 in T228. As a result, the user can receive the flat-rate service through the printer 10A.

### (Effects of Present Embodiment)

As described, in the case where the user ID “U1” is received from the terminal device 100 (T22 of FIG. 3 cited in FIG. 6), the service subscription request if received from the terminal device 100 (T32 of FIG. 3 cited in FIG. 6), and registration information is in the memory 334 in association with the user ID “U1”, the first SP server 200 acquires the registration information from the memory 334 (T212 in FIG. 6). Then, the first SP server 200 stores, in the case where the registration information is acquired from the memory 334, the registration information as information for providing the flat-rate service to the user in the memory 234 in association with the user ID “U1” (T228). Therefore, the user's convenience can be improved.

Further, in the case where the first SP server 200 sends a sending request to the second SP server 300 and receives registration information from the second SP server 300 (S20, YES in S22), the first SP server 200 stores the registration information in the first service table 238 in association with the user ID. Therefore, the user's convenience can be improved.

### (Correspondence Relationships)

In one aspect, the flat-rate service is an example of “first service”. The first SP server 200 is an example of “first server”. The user ID “U1” is an example of “user identification information”. The second SP server 300 is an example of “second server”. The first subscription screen data is an example of “input screen data”. The first subscription screen SC10 is an example of “input screen”. The registration information received in S26 of FIG. 5 is an example of “second registration information”. The registration information received in S22 of FIG. 5 is an example of “first registration information”. The registration information acquired in S30 of FIG. 5 is an example of “third registration information”. The information in the first history table 240 is an example of “history information”. The second subscription screen data is an example of “confirmation screen data”. The second subscription screen SC12 is an example of “confirmation screen”. The OK information is an example of “first information”. The change information is an example of “second information”. The second cartridge shipping service is an example of “second service”.

T22 in FIG. 3 is an example of “receive user identification information”. T32 in FIG. 3 is an example of “receive, from the terminal device, a service subscription request”. S20 in FIG. 5 is an example of “send a sending request”. S46 in FIG. 5 is an example of “store the first registration information”.

In another aspect, the flat-rate service is an example of “first service”. The first SP server 200 is an example of “first server”. The memory 234 is an example of “first memory”. The terminal device 100 is an example of “first external device”. The second cartridge shipping service is an example of “second service”. The user ID is an example of “user identification information”. The terminal device 100 is an example of “second external device”. The registration information received in S22 of FIG. 5 is an example of “first registration information”. The memory 334 is an example of “second memory”. The first subscription screen data is an example of “input screen data”. The first subscription screen SC10 is an example of “input screen”. The registration information received in S26 of FIG. 5 is an example of “second registration information”.

T22 in FIG. 3 is an example of “receive, from a first external device, user related information”. T32 in FIG. 3 is an example of “receive, from the terminal device, a service subscription request”. T212 in FIG. 6 is an example of “acquire the first registration information from the second memory”. S46 in FIG. 5 is an example of “store the first registration information”.

### Second Embodiment

A communication system 2 according to a second embodiment is described. As shown in FIG. 1, in the present embodiment, the memory 334 of the second SP server 300 stores an authentication table 342.

As shown in FIG. 2, the first service table 238 and the second service table 338 each further include model name and authentication device information. The authentication device information indicates a device to be used for device authentication. In this embodiment, the authentication device information includes a serial number and a model name. The authentication device information is registered when the user subscribes to a service. The user may register, as the authentication device information, information of a device to be used in a service the user is to subscribe to or information of a device which is different from the device to be used in the service.

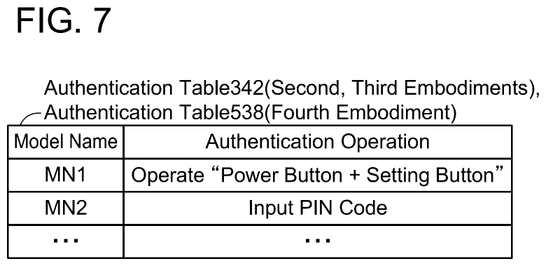

As shown in FIG. 7, a model name and an authentication operation are stored in association with each other in the authentication table 342. The authentication operation is information related to authentication via a device. In this embodiment, the model names “MN1” and “MN2” correspond to authentication operations “operation on power button+setting button” and “input of PIN code”, respectively. That is, respective model names correspond to different authentication operations. This improves security as compared to a case where there is only one authentication operation.

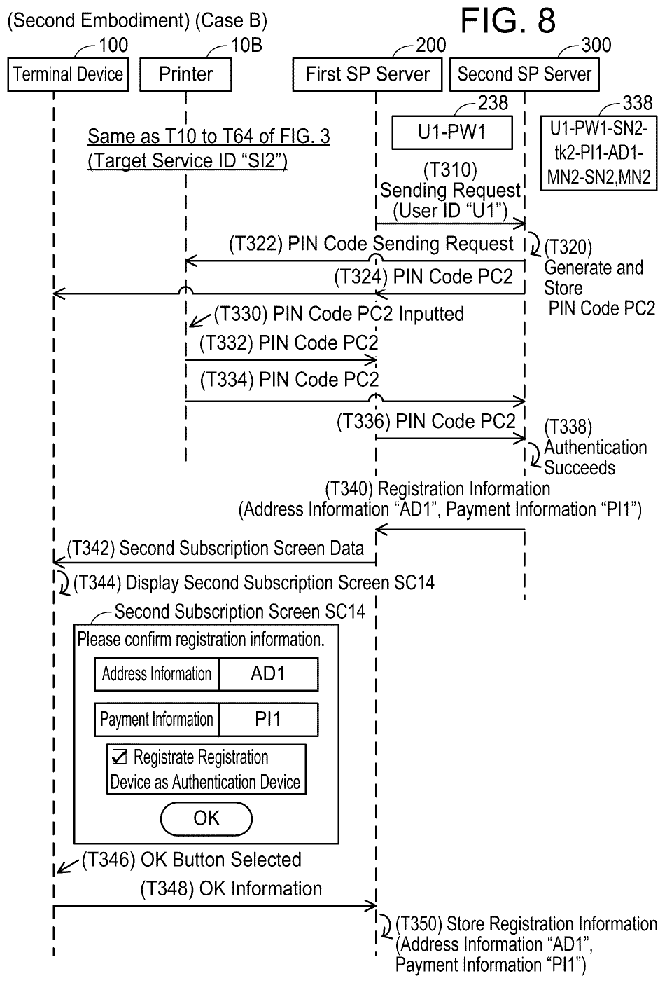

### (Case B: FIG. 8)

Referring to FIG. 8, Case B which can be realized by the communication system 2 according to the present embodiment is described. The initial state of Case B is the same as the initial state of Case A shown in FIG. 6, except that the serial number “SN2”, the model name “MN2”, and authentication device information “SN2, MN2” are stored in association with the user ID “U1” in the second service table 338.

First, the same sequence as T10 to T64 in FIG. 3 is executed between the printer 10A, the terminal device 100, and the first SP server 200. In this case, the user further inputs a target service ID “SI2” to the terminal device 100 in T30 of FIG. 3. A target service ID indicates a server to which a sending request is to be sent. In this embodiment, the CPU 232 of the first SP server 200 is configured to send a sending request to the server identified by a target service ID in S20 of FIG. 5. Further, the printer 10A sends a token request including the PIN code PC1, the seral number “SN1”, and the model name “MN1” to the first SP server 200 in T52.

In T310, the first SP server 200 sends a sending request including the user ID “U1” to the second SP server 300 identified by the target service ID “SI2” (S20 in FIG. 5).

In response to receiving the sending request from the first SP server 200 in T310, the second SP server 300 executes first device authentication via an authentication device. Specifically, the second SP server 300 specifies the user ID “U1” included in the sending request and then specifies authentication device information “SN2, MN2” associated with the user ID “U1” in the second service table 338. The second SP server 300 then determines that the authentication device information “SN2, MN2” is associated with only a single user ID in the second service table 338. In this case, the second SP server 300 specifies the serial number “SN2” and the model name “MN2” included in the authentication device information “SN2, MN2” and then specifies the authentication operation “input of PIN code” associated with the model name “MN2” in the authentication table 342. In this case, the second SP server 300 generates a PIN code PC2 and temporarily stores it in the memory 334 in T320. The second SP server 300 sends a PIN code sending request to the printer 10B identified by the serial number “SN2” in T322 and sends the PIN code PC2 to the terminal device 100 via the first SP server 200 in T324. The PIN code sending request is a signal that request a PIN code to be sent to the first SP server 200 and the second SP server 300.

In response to receiving the PIN code sending request from the second SP server 300 in T322 and accepting input of the PIN code PC2 in T330, the printer 10B sends the PIN code PC2 to the first SP server 200 in T332 and sends the PIN code PC2 to the second SP server 300 in T334.

In response to receiving the PIN code PC2 from the printer 10B in T332, the first SP server 200 sends the PIN code PC2 to the second SP server 300 in T336.

In response to receiving the PIN code PC2 from the printer 10B in T334 and receiving the PIN code PC2 from the first SP server 200 in T336, the second SP server 300 determines that the two received PIN codes PC2 match the PIN code PC2 stored in the memory 334 and thus determines that the first device authentication via the authentication device (i.e., the printer 10B) has succeeded in T338. In this case, the second SP server 300 specifies the registration information associated with the user ID “U1” in the second service table 338 (i.e., the address information “AD1” and the payment information “PI1”) and sends this registration information to the first SP server 200 in T340. If the first device authentication fails, the second SP server 300 sends failure information indicating that the first device authentication has failed to the first SP server 200.

In response to receiving the registration information from the second SP server 300 in T340 (YES in S22), the first SP server 200 sends second subscription screen data to the terminal device 100 in T342 (S40).

In response to receiving the second subscription screen data from the first SP server 200 in T342, the terminal device 100 displays a second subscription screen SC14 on the display unit 114 in T344. The second subscription screen SC14 is the same as the second subscription screen SC12 (see FIG. 5) according to the first embodiment, except that the former includes an authentication device setting field. The authentication device setting field is for selecting whether the printer used for the flat-rate service is to be registered as an authentication device or not. T346 and T348 are the same as T224 and T226 in FIG. 6, respectively. In T350, the first SP server 200 stores the registration information as information for providing the flat-rate service to the user in the first service table 238 in association with the user ID “U1”. The first SP server 200 further stores the authentication device information “SN1, MN1” in the first service table 238 in association with the user ID “U1”. As a result, the user is able to receive the flat-rate service using the printer 10A. If the first SP server 200 receives the failure information from the second SP server 300, the first SP server 200 determines that no registration information is received from the terminal device 100 (NO in S22) and sends the first subscription screen data to the terminal device 100 (S24).

If the OK button is operated after a check box in the setting field in the second subscription screen SC14 has been unchecked, the terminal device 100 displays an input screen for inputting information of a device to be registered as an authentication device. In response to information of a device being inputted, the terminal device 100 sends the OK information and the information of the device to the first SP server 200. In response to receiving the information of the device from the terminal device 100, the first SP server 200 stores the information of the device as authentication device information in the first service table 238. In this way, the user can designate a device different from a device used for a service as an authentication device. The user can designate the printer 10B and the terminal device 100 as authentication devices, although this is merely an example.

If the second SP server 300 determines that the authentication device information “SN2, MN2” is associated with not only the user ID “U1” but also another user ID after T310, the second SP server 300 sends impossible information indicating that sending of registration information is impossible to the first SP server 200 without executing T320 onward. In this case, the first SP server 200 determines that no registration information is received from the second SP server 300 (NO in S22) and sends the first subscription screen data to the terminal device 100 (S24). That is, the first SP server 200 does not receive registration information from the second SP server 300 regardless of whether the first device authentication has succeeded or not. This configuration suppresses the first SP server 200 to receive registration information when multiple users share an authentication device, thus improving security of registration information.

### (Effects of Case B)

As described, in the case where the first device authentication via the printer 10B has succeeded (T338), the first SP server 200 receives registration information stored in the memory 334 of the second SP server 300 (T340) and stores this registration information in the memory 234 (T350). Therefore, security of the registration information can be improved.

Further, the first SP server 200 receives the service ID “SI2” related to the second cartridge shipping service from the terminal device 100 and acquires registration information for providing the second cartridge shipping service to the user from the memory 334 of the second SP server 300. If the first SP server 200 does not receive a service ID from the terminal device 100, the first SP server 200 needs to inquire of each of memories of multiple SP servers whether registration information associated with the user ID “U1” is in the memory or not. According to the configuration above, the first SP server 200 only needs to inquire of the memory 334 of the second SP server 300 whether registration information associated with the serial number “SN2” is in the memory or not. This reduces the processing load of the first SP server 200.

### (Correspondence Relationships)

The authentication device information is an example of “device identification information”. The printer 10B is an example of “authentication device”. The printer 10B is an example of “first-type device”. The authentication operation “input of PIN code” is an example of “first predetermined operation”. The printer 10A is an example of “second-type device”. The authentication operation “operation on power button+setting button” is an example of “second predetermined operation”. The target service ID is an example of “service related information”.

### Third Embodiment

A communication system 2 according to a third embodiment is described. The communication system 2 according to this embodiment is the same as the communication system 2 according to the second embodiment. In the present embodiment, the first SP server 200 executes second device authentication via an authentication device.

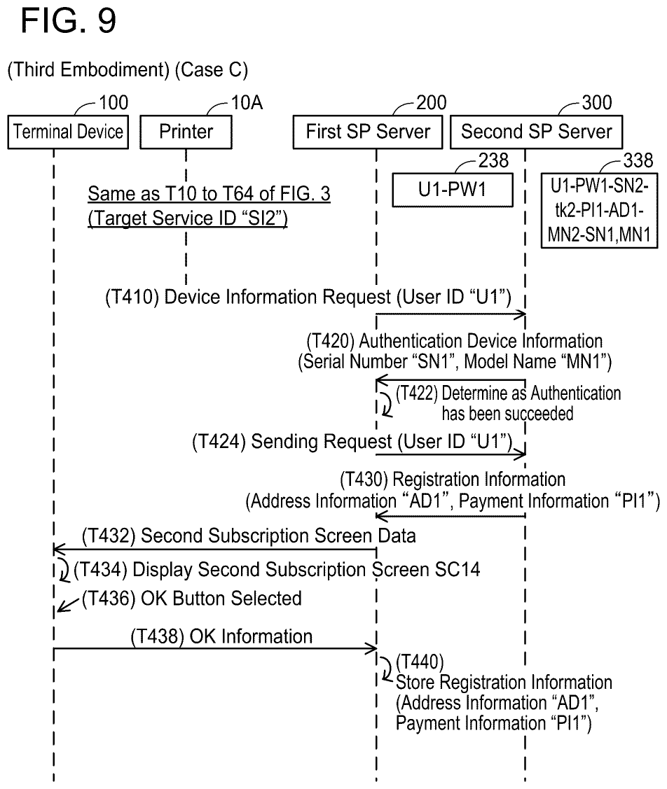

### (Case C: FIG. 9)

Referring to FIG. 9, a specific Case C which can be realized by the communication system 2 according to this embodiment is described. The initial state of Case C is the same as the initial state of Case B shown in FIG. 8, except that authentication device information “SN1, MN1” is stored in the second service table 338.

As with Case B in FIG. 8, the same sequence as T10 to T64 in FIG. 3 is executed between the printer 10A, the terminal device 100, and the first SP server 200.

In T410, the first SP server 200 sends a device information request including the user ID “U1” to the second SP server 300. The device information request is a signal that requests sending of authentication device information.

In response to receiving the device information request from the first SP server 200 in T410, the second SP server 300 specifies the authentication device information “SN1, MN1” associated with the user ID “U1” in the second service table 338 and then sends the authentication device information “SN1, MN1” to the first SP server 200 in T420.

In response to receiving the authentication device information “SN1, MN1” from the second SP server 300 in T420, the first SP server 200 specifies the serial number “SN1” included in the authentication device information “SN1, MN1”. In T54 of FIG. 3, the PIN code PC1 stored in T34 and the PIN code PC1 included in the token request match each other. That is, in T54, second device authentication via the authentication device (i.e., the printer 10A) has been succeeded. Therefore, the first SP server 200 determines that second device authentication via the printer 10A has succeeded. In this case, in T422 of FIG. 9, the first SP server 200 determines that the second device authentication via the printer 10A has already succeeded. The first SP server 200 then sends a sending request including the user ID “U1” to the second SP server 300 in T424. In a modification, the first SP server 200 may execute the second device authentication again after receiving the authentication device information “SN1, MN1” from the second SP server 300. In this case, the first SP server 200 may send the first subscription screen data to the terminal device 100 if the second device authentication fails.

In response to receiving the sending request from the first SP server 200 in T424, the second SP server 300 determines that the second device authentication has succeeded. T430 to T440 are the same as T340 to T350 in FIG. 8. As a result, the user is able to receive the flat-rate service using the printer 10A. In a modification, in response to sending the sending request including the user ID in T424, the first SP server 200 may receive authentication device information from the second SP server 300. In this modification, in response to the success of the second device authentication, the first SP server 200 may send information indicating that the second device authentication has succeeded to the second SP server 300. After this, T430 onward are executed.

### (Effects of Case C)

As described, in the case where the second device authentication via the printer 10A has succeeded (T54 in FIG. 3, T422 in FIG. 9), the first SP server 200 receives registration information stored in the memory 334 of the second SP server 300 (T430) and stores this registration information in the memory 234 (T440). Therefore, security of the registration can be improved.

### (Corresponding Relationship)

The printer 10A is an example of “authentication device”.

### Fourth Embodiment

A communication system 2 according to a fourth embodiment is described. As shown in FIG. 1, the communication system 2 according to this embodiment further includes an authentication server 500 storing an authentication table 538. The authentication server 500 is connected to the internet 6.

As shown in FIG. 7, the contents of the authentication table 538 are the same as those of the authentication table 342 according to the second embodiment.

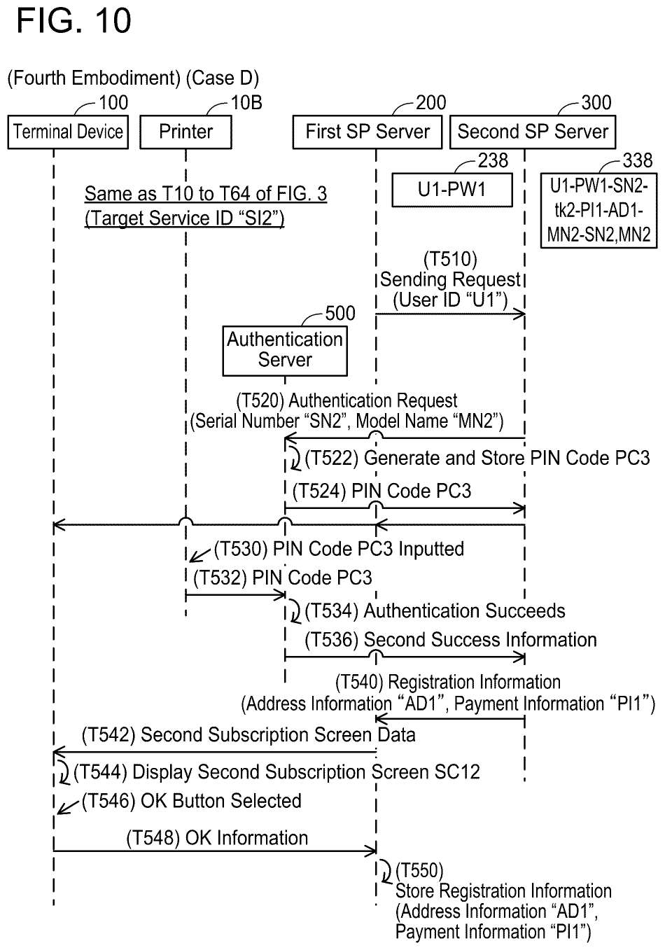

### (Case D: FIG. 10)

Referring to FIG. 10, Case D which can be realized by the communication system 2 according to this embodiment is described. The initial state of Case D is the same as the initial state of Case B shown in FIG. 8.

As with Case B in FIG. 8, the same sequence as T10 to T64 in FIG. 3 is executed between the printer 10A, the terminal device 100, and the first SP server 200. T510 is the same as T310 in FIG. 8.

In response to receiving the sending request from the first SP server 200 in T510, the second SP server 300 specifies the authentication device information “SN2, MN2” associated with the user ID “U1” in the second service table 338. The second SP server 300 then determines that the authentication device information “SN2, MN2” is associated with only a single user ID. In this case, the second SP server 300 specifies the serial number “SN2” and the model name “MN2” included in the authentication device information “SN2, MN2”, and sends an authentication request including the serial number “SN2” and the model name “MN2” to the authentication server 500 in T520. The authentication request is a signal that requests execution of third device authentication via an authentication device.

In response to receiving the authentication request from the second SP server 300 in T520, the authentication server 500 executes third device authentication. Specifically, the authentication server 500 specifies the model name “MN2” included in the authentication request and then specifies the authentication operation “input of PIN code” associated with the model name “MN2” in the authentication table 538. In this case, the authentication server 500 generates a PIN code PC3 and stores the generated PIN code PC3 in a memory (not shown) of the authentication server 500 in T522. The authentication server 500 sends the PIN code PC3 to the terminal device 100 via the second SP server 300 and the first SP server 200 in T524. The second SP server 300 sends the printer 10B a PIN code sending request to cause the printer 10B to send a PIN code to the authentication server 500, although this is not shown.

In response to accepting input of the PIN code PC3 in T530, the printer 10B sends the PIN code PC3 to the authentication server 500 in T532.

In response to receiving the PIN code PC3 from the printer 10B in T532, the authentication server 500 determines that the generated PIN code PC3 matches the received PIN code PC3, and thus determines that the third device authentication via the authentication device (i.e., the printer 10B) has succeeded in T534. In this case, the authentication server 500 sends second success information indicating that the third device authentication has succeeded to the second SP server 300 in T536. If the third device authentication fails, the authentication server 500 sends second failure information indicating that the third device authentication has failed to the second SP server 300.

In response to receiving the second success information from the authentication server 500 in T536, the second SP server 300 determines that the third device authentication has succeeded. T540 to T550 are the same as T340 to T350 in FIG. 8. As a result, the user is able to receive the flat-rate service using the printer 10A. The second SP server 300 does not send registration information to the first SP server 200 if receiving the failure information from the authentication server 500.

### (Effects of Case D)

As described, in the case where the third device authentication via the printer 10B has succeeded (T534), the first SP server 200 receives registration information stored in the memory 334 of the second SP server 300 (T540) and stores this registration information in the memory 234 (T550). Therefore, security of the registration information can be improved.

### (Corresponding Relationship)

The authentication request is an example of “authentication instruction”.

### Fifth Embodiment

A communication system 2 according to a fifth embodiment is described. In this embodiment, the first SP server 200 does not execute the registration process shown in FIG. 5.

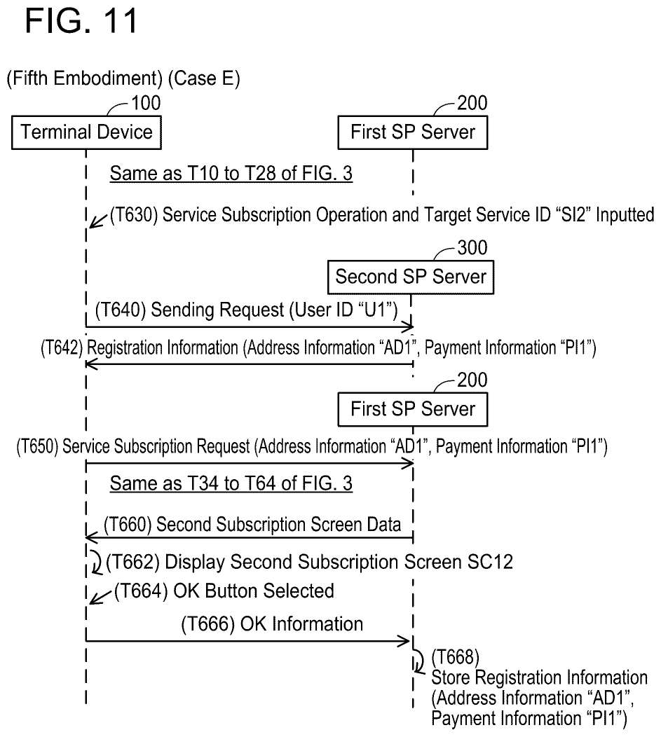

### (Case E: FIG. 11)

Referring to FIG. 11, Case E which can be realized by the communication system 2 according to this embodiment is described. The initial state of Case E is the same as the initial state of Case A shown in FIG. 6.

First, the same sequence as T10 to T28 in FIG. 3 is executed between the terminal device 100 and the first SP server 200.

In T630, the user performs a service subscription operation and an operation of inputting the target service ID “SI2” to the terminal device 100. In response, the terminal device 100 sends a sending request including the user ID “U1” to the second SP server 300 identified by the target service ID “SI2” in T640.

In response to receiving the sending request from the terminal device 100 in T640, the second SP server 300 specifies the registration information associated with the user ID “U1” in the second service table 338 (i.e., the address information “AD1” and the payment information “PI1”), and then sends the specified registration information to the terminal device 100 in T642. If no registration information is stored, the second SP server 300 sends non-storage information indicating that no registration information is stored to the first SP server 200.

In response to receiving the registration information from the second SP server 300 in T642, the terminal device 100 sends a service subscription request including the registration information to the first SP server 200 in T650. In a modification, the terminal device 100 may send a service subscription request and the registration information separately. If the terminal device 100 receives the non-storage information from the second SP server 300, the terminal device 100 sends a service subscription request that includes no registration information to the first SP server 200.

Then, the same sequence as T34 to T64 in FIG. 3 is executed between the terminal device 100, the printer 10A, and the first SP server 200. The first SP server 200 determines that the registration information has been received from the terminal device 100, and sends the second subscription screen data to the terminal device 100 in T660. If registration information has not been received from the terminal device 100, the first SP server 200 sends the first subscription screen data to the terminal device 100. T662 to T668 are the same as T222 to T228 in FIG. 6. As a result, the user is able to receive the flat-rate service using the printer 10A.

### (Effects of Present Embodiment)

As described, the terminal device 100 sends a sending request including the user ID “U1” to the second SP server 300. In the case where the terminal device 100 receives registration information from the second SP server 300, the terminal device 100 sends this registration information to the first SP server 200. The first SP server 200 then stores the registration information as information for providing the flat-rate service in association with the user ID “U1”. Therefore, the user's convenience can be improved.

### (Correspondence Relationships)

The first SP server 200 is an example of “first server”. The flat-rate service and the second cartridge shipping service are examples of “first service” and “second service”, respectively. The user ID “U1” is an example of “user related information”. The second SP server 300 is an example of “second server”. The registration information in T642 of FIG. 11 is an example of “specific registration information”.
(Modification 1) The second SP server 300 and the first SP server 200 may be examples of “first server” and “second server”, respectively. In this modification, the second cartridge shipping service and the flat-rate service are modifications of “first service” and “second service”, respectively. In this modification, the second SP server 300 executes the process of FIG. 5. The second SP server 300 uses the second history table 340 instead of the first history table 240 in S10. Further, the second SP server 300 sends the sending request to the first SP server 200 in S20. Moreover, in S28, S44, S46, the second SP server 300 stores the registration information as information for providing the second cartridge shipping service to the user in association with the user ID in the second service table 338. In another modification, the third SP server 400 may be an example of “first server” or “second server”.
(Modification 2) The communication system 2 may include a management server configured to store registration information for providing the flat-rate service to the user and registration information for providing the second cartridge shipping service to the user. In this modification, the CPU 232 of the first SP server 200 sends the sending request to the management server in S20 of FIG. 5 instead of sending it to the second SP server 300.
(Modification 3) “User identification information” is not limited to a user ID and may be an e-mail address, the name of a user, or the like.
(Modification 4) The first history table 240 may not be stored in the memory 234 of the first SP server 200. In this modification, S10 and S30 in FIG. 5 may be omitted. In this modification, “store the third registration information” may be omitted.
(Modification 5) S40 to S44 in FIG. 5 may be omitted. In this modification, in the case where registration information is acquired from the first history table 240 or in the case where registration information is received from the second SP server 300, the CPU 232 of the first SP server 200 stores the registration information received in S22 or the registration information acquired in S30 in the first service table 238 in association with the target user ID, without sending the second subscription screen data. In this modification, “send confirmation screen data” may be omitted.
(Modification 6) The second subscription screen SC12 may be configured not to allow a change in address information and payment information. In this modification, S42 and S44 in FIG. 5 may be omitted. In this modification, “store changed registration information” may be omitted.
(Modification 7) The CPU 232 of the first SP server 200 may send the sending request to the second SP server 300 and the third SP server 400 in S20 of FIG. 5. In this modification, if registration information is not received from either of the second SP server 300 nor the third SP server 400, the CPU 232 determines NO in S22 and executes S24 onward. Contrary to this, if registration information is received from at least one of the second SP server 300 and the third SP server 400, the CPU 232 determines YES in S22 and executes S40 onward. In another modification, the CPU 232 may send the sending request to the second SP server 300 before sending the sending request to the third SP server 400. In this modification, the CPU 232 sends the sending request to the third SP server 400 if determining NO in S22. Then, the CPU 232 may execute S24 onward if registration information is not received from the third SP server 400, whereas the CPU 232 may execute S40 onward if registration information is received from the third SP server 400.
(Modification 8) “Registration information” may be information including one of address information and payment information.
(Modification 9) In the embodiments above, the processes of FIGS. 3 to 6 and FIGS. 8 to 11 are implemented by software (e.g., by the programs 36,236,336), however, at least one of these processes may be implemented by hardware such as a logic circuit, etc.
(Modification 10) The first SP server 200 and the second SP server 300 may be physically the same server. In this case, the first SP server 200 and the second SP server 300 are built within a server. For example, it is contemplated that the first SP server 200 and the second SP server 300, which are a plurality of servers, may be built by different vendors or different business operators (or by the same vendor or the same business operator) within the physically same cloud server. In this case, communications (transmission and receipt of data) between the first SP server 200 and the second SP server 300 may be interior communications within the server, and the communication I/F 218 and the communication I/F 318 may be configured for both external communications and communications within the server. In this modification, “first memory” and “second memory” are the same memory.
(Modification 11) “User related information” is not limited to a user ID and may be a device ID, a serial number, a MAC address, or the like. If the serial number “SN1” is an example of “user related information”, the first SP server 200 sends a sending request including the serial number received from the printer 10A (e.g., see T52 in FIG. 3) to the second SP server 300 in S20 of FIG. 5. In this case, the second SP server 300 sends the registration information associated with the serial number “SN1” in the second service table 338 to the first SP server 200. In this modification, the printer 10A and the terminal device 100 are examples of “first external device” and “second external device”, respectively. Further, if the serial number “SN1” is an example of “user related information”, the first SP server 200 may be configured to receive a serial number from the terminal device 100. For example, the first SP server 200 receives a service subscription request including a serial number from the terminal device 100. In this case, the first SP server 200 sends a sending request including the serial number received from the terminal device 100 (e.g., see T52 in FIG. 3) to the second SP server 300 in S20 of FIG. 5. In this modification, the terminal device 100 is examples of “first external device” and “second external device”. Moreover, if the serial number “SN1” is an example of “user related information”, a user ID, address information, and payment information may be an example of “registration information”.
(Modification 12) The communication system 2 according to the fourth embodiment may include a mediation server configured to mediate communication with the printers. In this case, the authentication server 500 communicates with the printers via the mediation server.
(Modification 13) S22 to S28 in FIG. 5 may be omitted. In this modification, “send input screen data”, “receive the second registration information”, and “store the second registration information” may be omitted.
(Modification 14) In the first embodiment, the first SP server 200 may be configured to receive registration information from the second SP sever 300 in a case where two of the first, second, and third device authentication have succeeded. In another modification, the first SP server 200 may be configured to receive registration information from the second SP sever 300 in a case where all of the first, second, and third device authentication have succeeded.
(Modification 15) The second SP server 300 may execute T140 onward even when determining that the authentication device information “SN2, MN2” is associated with multiple user IDs after T310 in FIG. 8.
(Modification 16) In the second embodiment, the second SP server 300 may execute only the first device authentication corresponding to the authentication operation “input of PIN code”, regardless of the model name. In another modification, the second SP server 300 may vary the authentication operation used for the first device authentication depending on the timing at which a sending request is received. In yet another modification, the second SP server 300 may randomly vary the authentication operation used for the third device authentication. The same applies to the third device authentication in the fourth embodiment.
(Modification 17) In the second and fourth embodiments, the first service table 238 and the second service table 338 may not include authentication device information. In this modification, the second SP server 300 may execute device authentication via a printer having a serial number and a model name association with a user ID included in a sending request in the second service table 338. That is, a device used for device authentication may not be designated by the user.

What is claimed is:

1. A non-transitory computer-readable recording medium storing computer-readable instructions for a first server, wherein
the first server is configured to provide a first service, and
the first server comprises a processor,
wherein the computer-readable instructions, when executed by the processor, cause the first server to:
receive user identification information for identifying a user from a terminal device;
receive, from the terminal device, a service subscription request that requests a subscription to the first service;
in a case where the user identification information and the service subscription request are received from the terminal device, send a sending request including the user identification information to a second server different from the first server, the sending request being a signal that requests sending of registration information stored in the second server in association with the user identification information; and
in a case where the sending request is sent to the second server and first registration information is received from the second server, store the first registration information as information for providing the first service to the user in a memory in association with the user identification information, wherein in a case where the sending request is sent to the second server but no registration information is received from the second server, no registration information is stored in the memory.

2. The non-transitory computer-readable recording medium as in claim 1, wherein
the computer-readable instructions, when executed by the processor, further cause the first server to:
in the case where the sending request is sent to the second server but no registration information is received from the second server, send input screen data to the terminal device, the input screen data representing an input screen for inputting registration information;
in a case where second registration information is inputted by the user on the input screen displayed at the terminal device, receive the second registration information from the terminal device; and
in a case where the second registration information is received from the terminal device, store the second registration information as information for providing the first service to the user in the memory in association with the user identification information.

3. The non-transitory computer-readable recording medium as in claim 1, wherein
the computer-readable instructions, when executed by the processor, further cause the first server to:
in a case where the user identification information and the service subscription request are received from the terminal device and history information in which the user identification information and third registration information are associated with each other is in the memory, store the third registration information as information for providing the first service to the user in the memory in association with the user identification information, wherein the history information was used when the user subscribed to the first service in the past,
wherein in a case where the user identification information and the service subscription request are received from the terminal device and the history information is not in the memory, the sending request is sent to the second server, and
in the case where the user identification information and the service subscription request are received from the terminal device and the history information is in the memory, the sending request is not sent to the second server.

4. The non-transitory computer-readable recording medium as in claim 1, wherein
the computer-readable instructions, when executed by the processor, further cause the first server to:
in the case where the sending request is sent to the second server and the first registration information is received from the second server, send confirmation screen data to the terminal device, the confirmation screen data representing a confirmation screen including the first registration information,
wherein in a case where first information corresponding to storage of the first registration information in the memory is received from the terminal device after the confirmation screen data has been sent to the terminal device, the second registration information is stored in the memory in association with the user identification information.

5. The non-transitory computer-readable recording medium as in claim 3, wherein
the confirmation screen is configured to allow the first registration information to be changed,
wherein the computer-readable instructions, when executed by the processor, further cause the first server to:
in a case where second information corresponding to a change in the first registration information is received from the terminal device after the confirmation screen data has been sent to the terminal device, store changed registration information as information for providing the first service to the user in the memory in association with the user identification information.

6. The non-transitory computer-readable recording medium as in claim 1, wherein
the second server is configured to provide a second service different from the first service, and
the first registration information is stored in the second server as information for the second server to provide the second service to the user.

7. The non-transitory computer-readable recording medium as in claim 1, wherein
the registration information includes at least one of address information and payment information.

8. A non-transitory computer-readable recording medium storing computer-readable instructions for a first server, wherein
the first server is configured to provide a first service,
the first server comprises a processor and a first memory,
wherein the computer-readable instructions, when executed by the processor, cause the first server to:
receive, from a first external device, user related information for providing a second service different from the first service to a user;
receive, from a second external device, a service subscription request that requests a subscription to the first service;
in a case where the user related information is received from the first external device, the service subscription request is received from the second external device, and first registration information is in a second memory in association with the user related information as information for providing the second service to the user, acquire the first registration information from the second memory,
wherein in a case where the user related information is received from the first external device, the service subscription request is received from the second external device, and no registration information is in the second memory in association with the user related information as information for providing the second service to the user, registration information is not acquired; and
in a case where the first registration information is acquired from the second memory, store the first registration information as information for providing the first service to the user in the memory in association with the user related information.

9. The non-transitory computer-readable recording medium as in claim 8, wherein
the computer-readable instructions, when executed by the processor, further cause the first server to:
in the case where the user related information is received from the first external device, the service subscription request is received from the second external device, and no registration information is in the second memory in association with the user related information as information for providing the second service to the user, send input screen data to the second external device;
in a case where second registration information is inputted by the user on an input screen represented by the input screen data, receive the second registration information from the second external device; and
in a case where the second registration information is received from the second external device, store the second registration information as information for providing the first service to the user in the first memory in association with the user related information.

10. The non-transitory computer-readable recording medium as in claim 8, wherein
the first registration information is acquired from the second memory in a case where the user related information is received from the first external device, the service subscription request is received from the second external device, the first registration information is in the second memory in association with the user related information as information for providing the second service to the user, and authentication using an authentication device identified by device identification information stored in the second memory in association with the user related information succeeds.

11. The non-transitory computer-readable recording medium as in claim 10, wherein
a second server different from the first server comprises the second memory, and
the second server is configured to provide the second service,
wherein the computer-readable instructions, when executed by the processor, further cause the first server to:
in the case where the user related information is received from the first external device and the service subscription request is received from the second external device, send a sending request including the user related information to the second server,
wherein the second server is configured to:
in a case where the sending request is received from the first server, execute the authentication using the authentication device identified by the device identification information stored in the second memory in association with the user related information included in the sending request; and
in a case where the authentication succeeds, supply the first registration information in the second memory to the first server,
wherein the first registration information is acquired from the second memory by receiving the first registration information from the second server.

12. The non-transitory computer-readable recording medium as in claim 10, wherein
a second server different from the first server comprises the second memory, and
the second server is configured to provide the second service,
wherein the computer-readable instructions, when executed by the processor, further cause the first server to:
in the case where the user related information is received from the first external device and the service subscription request is received from the second external device, send a sending request including the user related information to the second server,
wherein the second server is configured to:
in a case where the sending request is received from the first server, send an authentication server an authentication instruction including the device identification information stored in the second memory in association with the user related information included in the sending request; and
in a case where information indicating that the authentication has succeeded is received from the authentication server, supply the first registration information in the second memory to the first server,
wherein the first registration information is acquired from the second memory by receiving the first registration information from the second server.

13. The non-transitory computer-readable recording medium as in claim 10, wherein
a second server different from the first server comprises the second memory, and
the second server is configured to provide the second service,
wherein the computer-readable instructions, when executed by the processor, further cause the first server to:
in the case where the user related information is received from the first external device and the service subscription request is received from the second external device, execute the authentication using the authentication device identified by the device identification information stored in the second memory in association with the user related information,
wherein in a case where the authentication succeeds, the first registration information is acquired from the second memory by receiving the first registration information from the second server.

14. The non-transitory computer-readable recording medium as in claim 10, wherein
in a case where the user related information is received from the first external device and the service subscription request is received from the second external device under a state where the device identification information, the user related information and first registration information are in the second memory in association with each other and the device identification information is in the second memory in association with registration information different from the first registration information, the first registration information is not acquired regardless of whether the authentication succeeds or not.

15. The non-transitory computer-readable recording medium as in claim 10, wherein
in a case where the authentication device is a first-type device, the authentication includes a first predetermined operation to the authentication device, and
in a case where the authentication device is a second-type device different from the first-type device, the authentication includes a second predetermined operation to the authentication device, the second predetermined operation being different from the first predetermined operation.

16. The non-transitory computer-readable recording medium as in claim 10, wherein
the computer-readable instructions, when executed by the processor, further cause the first server to:
in a case where the second service is designated from among a plurality of services at the second external device, receive service related information related to the second service from the second external device,
wherein the first registration information is acquired from the second memory in a case where the user related information is received from the first external device, the service subscription request and the service related information are received from the second external device, and the authentication using the authentication device used for the second service related to the service related information succeeds.

17. A non-transitory computer-readable recording medium storing computer-readable instructions for a terminal device, wherein
the terminal device comprises a processor,
wherein the computer-readable instructions, when executed by the processor, cause the terminal device to:
send a second server a sending request including user related information related to information for providing a second service to a user, wherein the second service is different from a first service provided by a first server, and the sending request is a signal that requests sending of registration information stored in the second server in association with the user related information;
in a case where the sending request is sent to the second server and specific registration information is in the second server in association with the user related information, receive the specific registration information from the second server, wherein in a case where the sending request is sent to the second server and no registration information is in the second server in association with the user related information, registration information is not received from the second server;
in a case where the specific registration information is received from the second server, send the specific registration information to the first server;
send the user related information to the first server; and
send the first server a service subscription request that requests a subscription to the first service, wherein in a case where the specific registration information is received from the terminal device, the user related information is received from the terminal device, and the service subscription request is received from the terminal device, the first server is configured to store the specific registration information as information for providing the first service to the user in association with the user related information.
